(19) United States
(12) Patent Application Publication
(10) Pub. No.: US 2025/0363322 A1
(43) Pub. Date: Nov. 27, 2025

(54) PRINTING DATA LAYOUT METHOD

(71) Applicant: Eastman Kodak Company, Rochester, NY (US)

(72) Inventors: Jenson John Crawford, Culver City, CA (US); Patrick David Kerr, North Vancouver (CA); James Peter Barnes, Prior Lake, MN (US)

(21) Appl. No.: 19/069,494

(22) Filed: Mar. 4, 2025

Related U.S. Application Data
(60) Provisional application No. 63/650,972, filed on May 23, 2024.

(51) Int. Cl. G06K 15/02

(52) U.S. Cl. CPC G06K 15/1885; G06K 15/1807

(57) ABSTRACT

A method for laying out printing data for a printing system includes forming component models for each printing system component that specify associated restrictions. A useable layout area for the printing system is determined based on the restrictions associated with the printing system components and a graphical representation of the restrictions and the useable layout area are displayed on a softcopy display. An initial layout position of printing data for a print job is specified relative to the useable layout area. An adjusted layout position is determined and a representation of the printing data in the adjusted layout position is superimposed with the graphical representation of the restrictions on the softcopy display.

### FIELD OF THE INVENTION

This invention pertains to the field of digital printing and more particularly to laying out printing data for a printing system.

### BACKGROUND OF THE INVENTION

A commercial printing production line (i.e., a printing system) utilizes a unique configuration of devices (i.e., printing system components) and substrates to produce a printed product. Devices perform specific functions within the production line. Devices can include printing modules (e.g., printing presses), unwinders and rewinders, pre- and post-coaters, cutters, stitchers, etc. Substrates are the materials onto which image content (e.g., images, text, or designs) can be printed. Substrates include varieties of paper, vinyl, plastic, and fabric. For example, FIG. 1 illustrates a printing system 200 that includes a sequence of four printing system components: an unwinder 205A, a pre-coater 205B, a printing press 205C and an in-line finishing system 205D.

Each device and substrate have a unique set of restrictions and/or limitations limiting where image content can be printed. For example, substrates can have obvious restrictions based on their physical size, but they can also have other restrictions such as the maximum allowable ink coverage. Devices can have limitations such as the width, length, or thickness on which they can print/operate. They can also have limitations such as the space required for registration marks needed to align multiple printing passes/operations.

The process of laying out the printing data associated with a print job so that it is properly aligned as it is processed by each of the printing system components to produce the final printed product can be quite complex, and can sometimes require an iterative trial-and-error process. One aspect of the layout process for multi-page print jobs is referred to as imposition. Imposition is the process of arranging a print jobs pages so that once the printed sheets are folded and trimmed, the pages will appear in the correct order. The imposition process relies on proper alignment of the printed image data with the folding and cutting systems. With traditional manual layout processes, it can be difficult to determine how to optimize the layout to efficiently utilize the media and minimize waste.

There remains a need for an improved layout process that can provide an optimized layout, accounting for the restrictions and/or limitations associated with each of the printing system components, and minimizing waste.

### SUMMARY OF THE INVENTION

The present invention represents a method for laying out printing data for a printing system including a plurality of printing system components, the plurality of printing system components including at least one printing module for printing on a substrate, comprising:
forming a component model for each of the plurality of printing system components, wherein the component models specify restrictions associated with the corresponding printing system components;
receiving a print job including printing data for one or more pages;
determining a useable layout area for the printing system based on the restrictions associated with the corresponding printing system components;
displaying a graphical representation of the restrictions associated with the plurality of printing system components together with the useable layout area on a softcopy display;
specifying an initial layout position of the printing data relative to the useable layout area;
adjusting the layout position of the printing data or a geometry of layout area to specify an adjusted layout position; and
superimposing a representation of the printing data in the adjusted layout position together with the graphical representation of the restrictions on the softcopy display.

This invention has the advantage that complex printing systems can be modeled to simplify the layout and imposition process for print jobs.

It has the additional advantage that the layout position for a print job can be optimized to reduce substrate usage.

### BRIEF DESCRIPTION OF THE DRAWINGS

FIG. 1 illustrates an exemplary printing system;

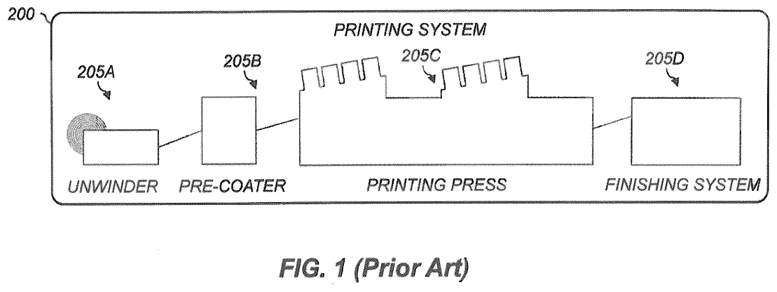

FIG. 2 is a flow chart of an exemplary method for laying out printing data in accordance with the present invention;

FIG. 3 illustrates the formation of a printing system model corresponding to the printing system of FIG. 1;

FIG. 4 illustrates the formation of a substrate supply model;

FIG. 5 illustrates the formation of a pre-coater model;

FIG. 6 illustrates the formation of a printing press model;

FIG. 7 illustrates the formation of a finishing system model;

FIG. 8 shows an example user interface for displaying a graphical representation of the restrictions associated with a set of printing system components;

FIG. 9 illustrates an exemplary print job for an 8-page booklet;

FIG. 10 illustrates a representation of the printing data for a print job in an initial layout position superimposed with the graphical representation of the restrictions associated with the set of printing system components;

FIG. 11 illustrates a representation of the printing data in an adjusted layout position for the print job superimposed with the graphical representation of the restrictions associated with the set of printing system components in an initial layout position;

FIG. 12 illustrates the operations performed by the finishing system for an exemplary print job; and

FIG. 13 illustrates the printed product corresponding to the exemplary print job.

It is to be understood that the attached drawings are for purposes of illustrating the concepts of the invention and may not be to scale. Identical reference numerals have been used, where possible, to designate identical features that are common to the figures.

### DETAILED DESCRIPTION OF THE INVENTION

In the following description, some embodiments of the present invention will be described in terms that would ordinarily be implemented as software programs. Those skilled in the art will readily recognize that the equivalent of such software may also be constructed in hardware. Because image manipulation algorithms and systems are well known, the present description will be directed in particular to algorithms and systems forming part of, or cooperating more directly with, the method in accordance with the present invention. Other aspects of such algorithms and systems, together with hardware and software for producing and otherwise processing the image signals involved therewith, not specifically shown or described herein may be selected from such systems, algorithms, components, and elements known in the art. Given the system as described according to the invention, software not specifically shown, suggested, or described herein that is useful for implementation of the invention is conventional and within the ordinary skill in such arts.

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art. The use of singular or plural in referring to the “method” or “methods” and the like is not limiting. It should be noted that, unless otherwise explicitly noted or required by context, the word “or” is used in this disclosure in a non-exclusive sense.

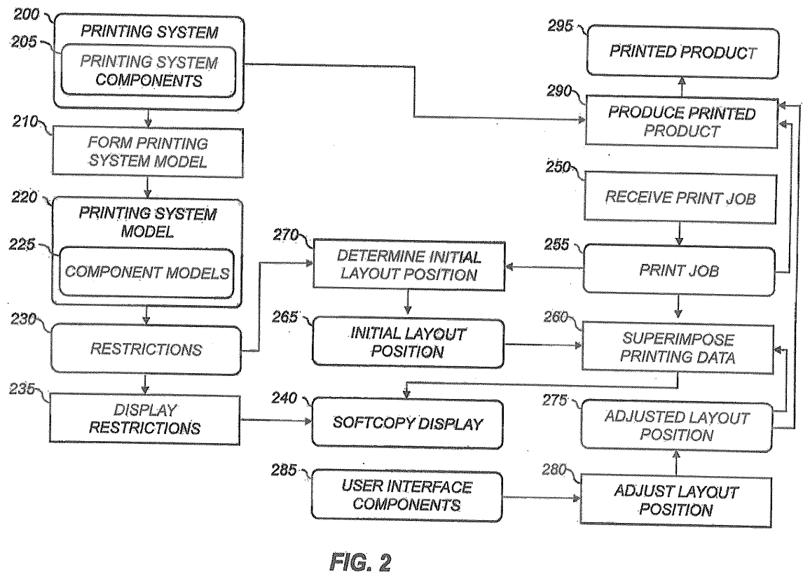

The present invention will now be described with reference to FIG. 2 which illustrates a method for laying out printing data for a printing system 200 in accordance with an exemplary embodiment. The printing system 200 includes a plurality of printing system components 205 which can be utilized sequentially to produce a printed product 295. The printing system components 205 will generally include one or more printing modules for printing on a substrate. Examples of different types of printing modules would include inkjet printing modules (sometimes referred to as inkjet printing presses), electrophotographic printing modules, offset printing presses or flexographic printing presses. In an exemplary embodiment, the printing module is a KODAK PROSPER ULTRA 520 Press. Depending on the equipment owned by a particular vendor and the requirements of the printed product 295, the printing system 200 can be configured to include a wide variety of other printing system components such as a substrate supply, a system, a folding system, a binding system, or a finishing system.

A form printing system model step 210 is used to form a printing system model 220 which models the printing system 200. The printing system model 220 includes a plurality of component models 225 corresponding to each of the printing system components 205. The printing system model 220 can be viewed as a “digital twin” of the printing system 200. The printing system model 220 is an effectively indistinguishable digital counterpart of the printing system 200 when it comes to layout and imposition for printing.

The component models 225 specify a set of specifications and constraints that are associated with the corresponding printing system components 205. The specifications and constraints can together be referred to as restrictions 230 (or limitations) that limit or govern the use of the printing system components 205. The restrictions can be physical restrictions or logical restrictions.

The term “specification” will be used to refer to restrictions that are fundamental attributes of the printing system components 205. Examples of specifications that can be associated with various printing system components would include: material properties (e.g., substrate type, substrate dimensions, weight, thickness, opacity, maximum allowable colorant coverage), speed, limitations on the substrate dimensions on which the printing system components 205 can operate (e.g., maximum printable area), number of colorants (e.g., inks), and restrictions on the positions of cuts/folds. The term “constraint” will be used to refer to restrictions that are related to the way the device will be used. Example constraints would include: pre-coating should not be applied to within 0.25″ of the edge of the media, and image content should not be printed in the location of registration marks.

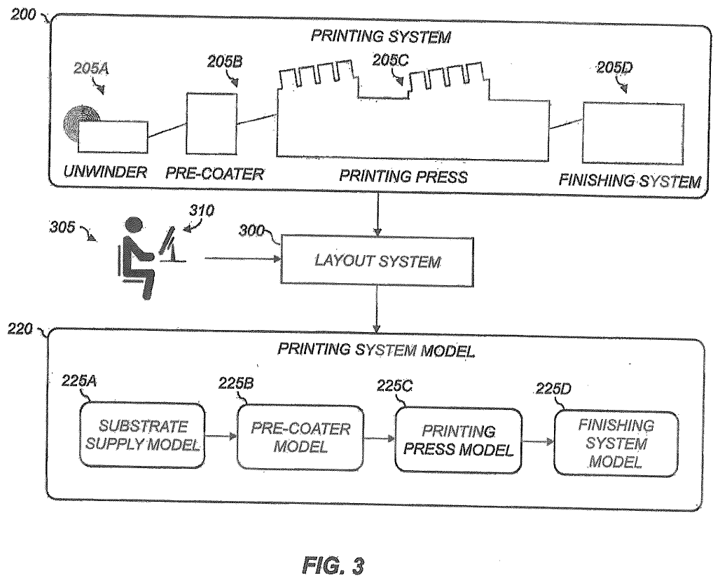

In some embodiments, the printing system model 220 is formed by providing a user-interface that enables a user to assemble/order the component models 225 for each of the printing system components 205 in the printing system 200. The component models 225 can be defined by enabling the user to manually specify the device type, together with the associated specifications and constraints. For example, FIG. 3 illustrates a layout system 300 that includes a user interface 310 enabling a user 305 to form a printing system model 220 by assembling component models 225A, 225B, 225C, 225D corresponding to the printing system components 205A, 205B, 205C, 205D of a printing system 200. The user interface can include elements such as a keyboard, a pointing device (e.g., a mouse or a trackpad), a softcopy display, and software including appropriate graphical user interface features (e.g., graphical display windows, menus, dialog boxes, etc.).

The printing system components 205 in the exemplary printing system 200 of FIG. 3 include an unwinder 205A, a pre-coater 205B, a printing system 205C and a finishing system 205D. In the illustrated example, the printing press 205C can be a KODAK PROSPER ULTRA 520 Press, and the other components can be generic devices having specified characteristics. It will be obvious to one skilled in the art that the present invention can be applied to printing systems with a wide variety of different/additional printing system components 205.

In some embodiments, at least some of the restrictions associated with one or more of the printing system components 205 are specified by automatically querying the printing system components 205. This is possible for printing system components 205 that provide a software interface which supports such query operations. For example, printing system components 205 that support the industry-standard JDF specification can be queried to determine various device capability (DevCap) attributes.

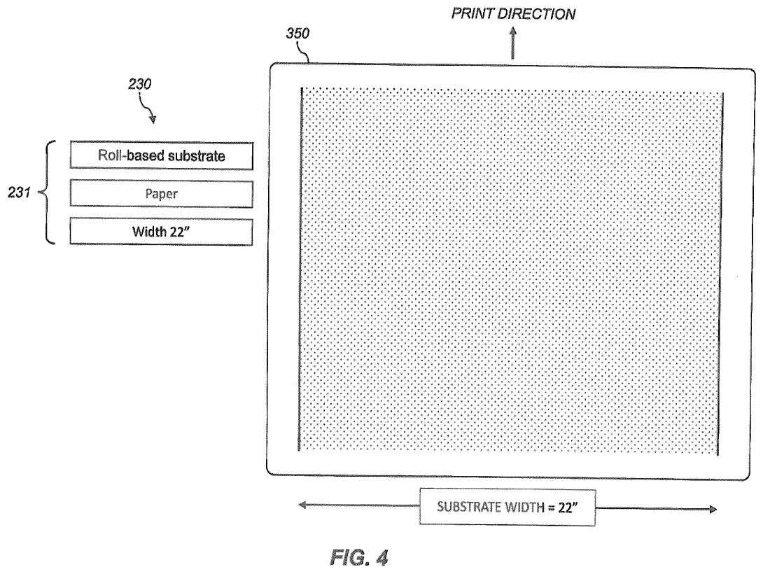

FIGS. 4-7 illustrate the manual formation of an exemplary printing system model 220 corresponding to the printing system 200 of FIG. 3 using the user interface 310 of the layout system 300.

FIG. 4 illustrates the user interface 310 for defining the substrate supply model 225A corresponding to the substrate supplied from unwinder 205A (FIG. 3) of the printing system 200. The defined restrictions 230 include specifications 231 that the device is a roll-based substrate supply, and that the substrate is paper having a width of 22″. A graphical representation 350 of the geometrical restriction shows that the substrate has a defined width of 22″ and an unspecified length.

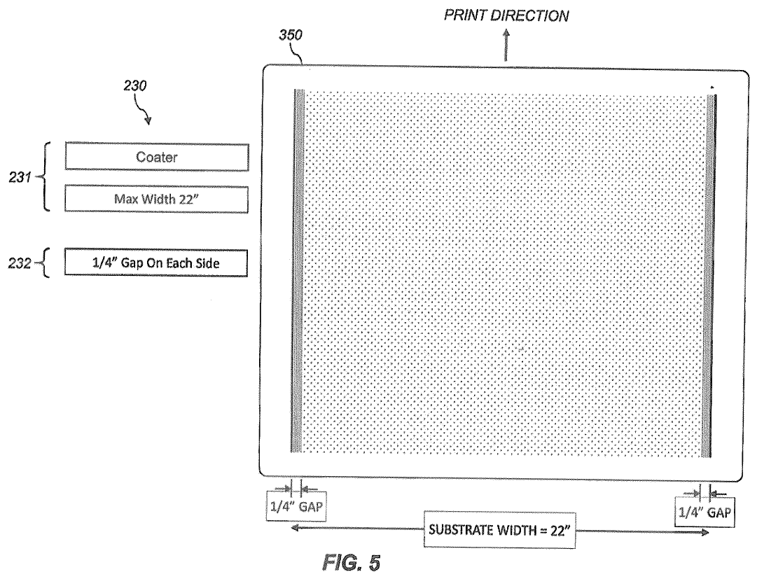

FIG. 5 illustrates the user interface 310 for defining the pre-coater model 225B corresponding to the pre-coater 205B (FIG. 3) of the printing system 200. The defined restrictions 230 include specifications 231 that the device is a coater, and that the maximum coating width is 22″. The restrictions 230 in this example also include a constraint 232 that there is a ¼″ gap along each edge of the substrate where no coating is applied. The graphical representation 350 has been updated to illustrate the uncoated gap regions along the left and right edges of the substrate.

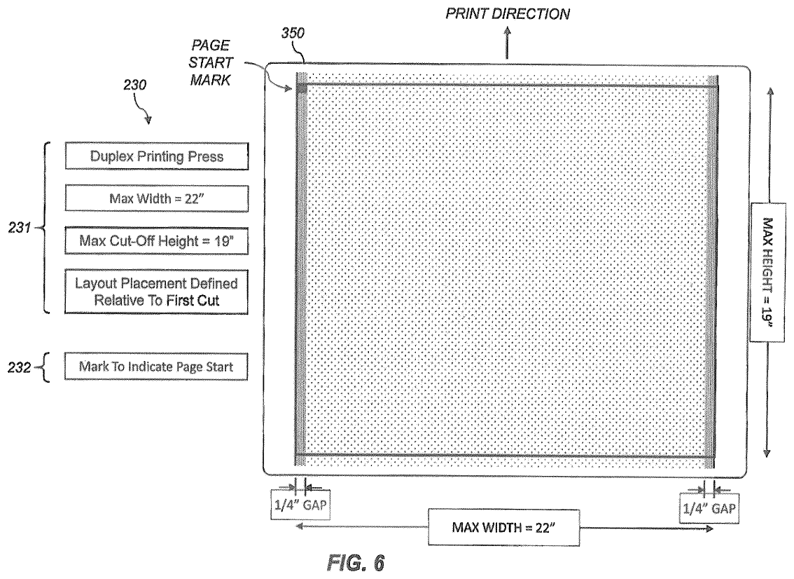

FIG. 6 illustrates the user interface 310 for defining the printing press model 225C corresponding to the printing press 205C (FIG. 3) of the printing system 200. The defined restrictions 230 include specifications 231 that the device is a duplex printing press, the maximum printing width is 22″, the maximum cut-off height is 19″ (which defines the maximum printing height), and that the layout placement is defined relative to the first cut (toward the top of the figure). The defined restrictions 230 in this example also include a constraint 232 that a mark to indicate page start will be printed (in the upper left corner). The graphical representation 350 has been updated to illustrate the maximum height and page start mark.

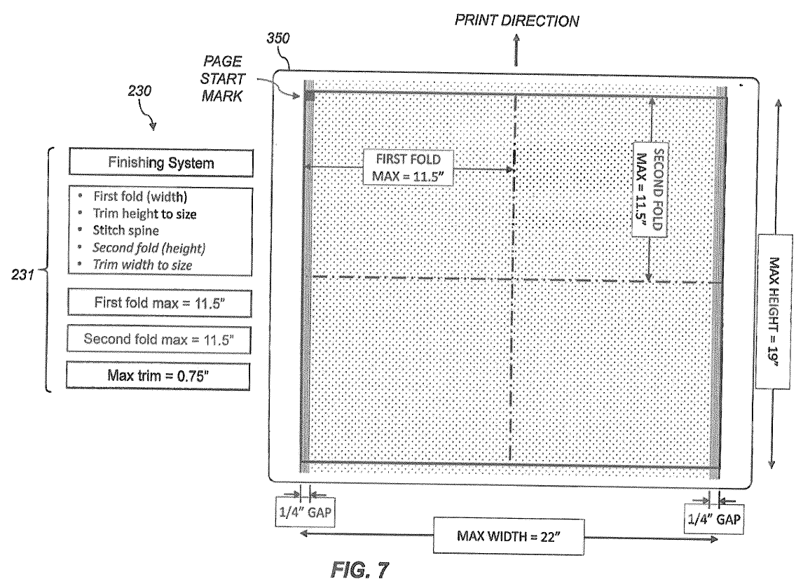

FIG. 7 illustrates the user interface 310 for defining the finishing system model 225D corresponding to the in-line finishing system 205D (FIG. 3) of the printing system 200. The defined restrictions 230 include specifications 231 that the device is a finishing system which is configured to perform a first folding operation, a first trimming operation, a stitching operation, a second folding operation and a second trimming operation, where the two folds must be positioned no more than 11.5″ from the substrate edges, and where the maximum trim amount is 0.75″. The graphical representation 350 has been updated to illustrate default fold positions.

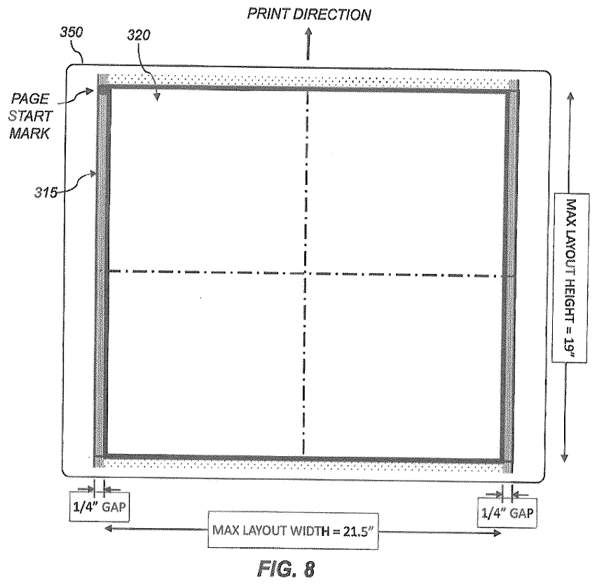

Returning to a discussion of FIG. 2, once the printing system model 220 corresponding to the printing system 200 has been formed, a display restrictions step 235 is used to display a graphical representation 350 (FIG. 7) of the restrictions 230 associated with the printing system components 205 on a softcopy display 240 (e.g., a display associated with the user interface 310 of the layout system 300 (FIG. 3). The displayed restrictions 230 from each of the printing system components 205 for an exemplary printing system model 220 are shown in FIG. 7. The restrictions 230 associated with each of the printing system components 205 can be combined to define a useable layout area 320 as shown in FIG. 8. Typically, the restrictions have the effect of reducing the useable layout area 320 relative to a maximum layout area 315. The useable layout area 320 can be displayed on the softcopy display 240 together with the restrictions 230. The usable layout area 320 represents the portion of the substrate where image content for the printed product 295 can be printed using the specified configuration of the printing system components 205. In this case, the maximum layout area will be 22″ wide (the width of the substrate supplied by the unwinder 205A) and 19″ high (the maximum cut-off height of the printing press 205C). The useable layout area 320 has a maximum layout width of 21.5″ (corresponding to the 22″ substrate width reduced by the ¼″ gaps from the pre-coater 205B on the left and right edges).

Returning to a discussion of FIG. 2, a receive print job step 250 is used to receive a print job 255 including printing data for one or more pages to be printed using the printing system 200. The printing data specifies what content (e.g., images, text, graphics) is to be printed at what relative positions. The printing data can be specified in any appropriate format. For example, the printing data can be specified using a page description format such as the industry-standard JDF specification defined by CIP4.

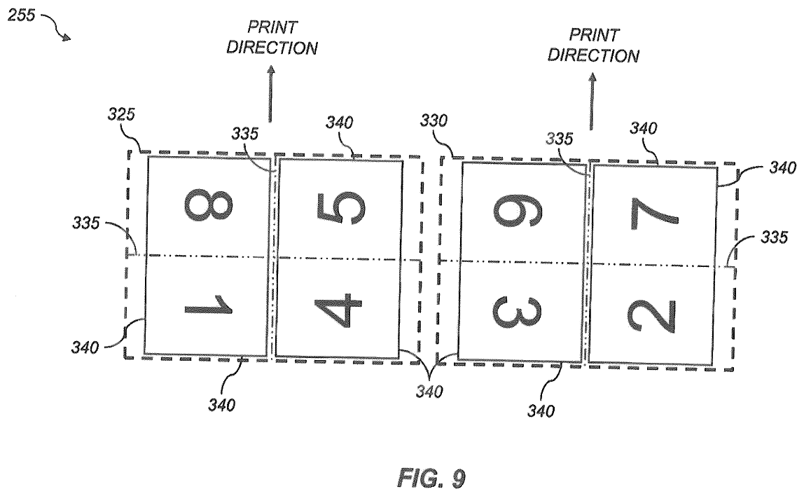

FIG. 9 illustrates an exemplary print job 255 for a printed product consisting of an 8-page booklet having a size of 8.25″×10.25″ (with a 0.125″ bleed on the page edges that will be cut). The booklet is formed by using the printing press 205C (FIG. 3) to print a front side 325 with a four page imposition (page #1, #4, #5, #8) and a back side 330 with a four page imposition (pages #2, #3, #6, #7). The finishing system 205D (FIG. 3) is then used to fold the printed substrate along fold lines 335, trim the edges along cut lines 340 and stitch the spine to produce the final printed product 295 (FIG. 2).

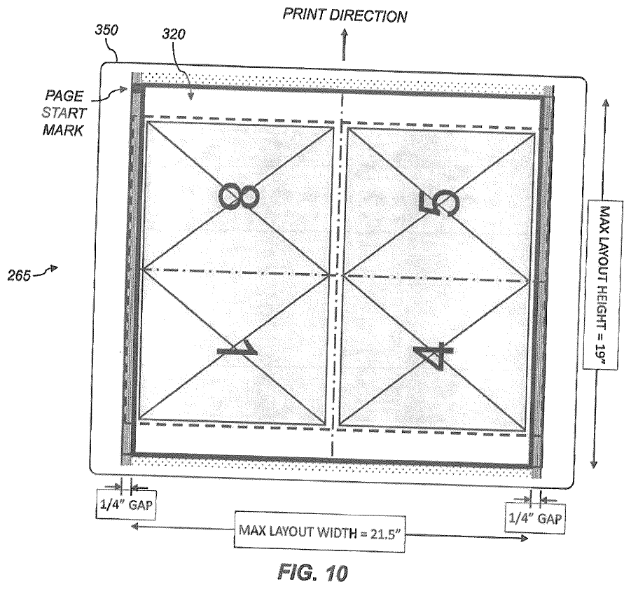

A superimpose printing data step 260 (FIG. 2) is then used to superimpose a representation of the printing data for the print job 255 together with the graphical representation of the restrictions 230 and the useable layout area 320 associated with the printing system components 205 on the softcopy display 240 as illustrated in FIG. 10. The representation of the printing data can be a low-resolution representation (i.e., a “thumbnail” representation) of the image content to be printed by the printing system 200 (FIG. 3). Alternatively, it can simply be a graphical element indicating the position and size of the image content (e.g., a rectangular box representing the page size overlaid with a number indicating the page number as in FIG. 10). The representation of the printing data is initially displayed in an initial layout position 265 determined by a determine initial layout position step 270 (FIG. 2). In some embodiments, the determine initial layout position step 270 can determine the initial layout position 265 by automatically analyzing the printing data to determine an acceptable layout position. For example, the initial layout position 265 can be the position that centers the printing data within the useable layout area 320 (as in the example shown in FIG. 10). Alternatively, the initial layout position 265 can position the printing data along the leading edge of the useable layout area 320, with a pre-defined gap (e.g., 0.125″) between the leading edge of the printing data and the leading edge of the useable layout area 320. In cases where the printing data includes an imposition with a plurality of pages the initial layout position 320 can be determined such that the pages are aligned appropriately with default cut line positions associated with a cutting system or default fold line positions associated with a folding system. In other embodiments, a more complex algorithm can be used to determine the initial layout position 265 that is the best estimate of an optimal layout position (e.g., the layout position that minimizes substrate waste).

Next, an adjust layout position step 280 is used to adjust the layout position of the printing data relative to the useable layout area 320 to determine an adjusted layout position 275. In some embodiments, this step can be performed automatically by applying one or more pre-defined criteria. For example, to minimize the substrate usage for printing the print job, the initial layout position 265 can position the printing data along the leading edge of the useable layout area 320, with a pre-defined gap (e.g., 0.125″) between the leading edge of the printing data and the leading edge of the useable layout area 320. The adjust layout position step 280 can then adjust the geometry of the layout area. For example, the in-track height of the layout area can be reduced based on the in-track height of the printing data in the adjusted layout position 275 (with appropriate gaps at the top and bottom for trimming) to minimize substrate waste. The positions of the cut lines and the fold lines can then be adjusted accordingly in accordance with the adjusted layout position 275. (Within the context of the present disclosure the positions of the cut lines and the fold lines are considered to be attributes of the geometry of the layout area.)

In some embodiments, user interface components 285 (FIG. 2) can be provided to enable a user to manually perform the adjust layout position step 280 to adjust the layout position of the printing data relative to the useable layout area 320 to determine an adjusted layout position 275. For example, the adjust layout position step 280 can enable the user to drag the printing data around to different positions within the useable layout area 320 using user interface components 285 such as a pointing device (e.g. a mouse or a trackpad). In some embodiments, arrow keys on a keyboard can be used to “nudge” the layout position. User interface features can also be provided to align the printing data with features such as cut lines and fold lines. (For example, a page boundary and a fold line can be selected by the user and an alignment button can be selected to align the features.

Once the adjusted layout position 275 has been specified, the softcopy display 240 can be updated accordingly. Preferably, the softcopy display 240 is updated in real-time as the layout position and the geometry of the useable layout area are adjusted.

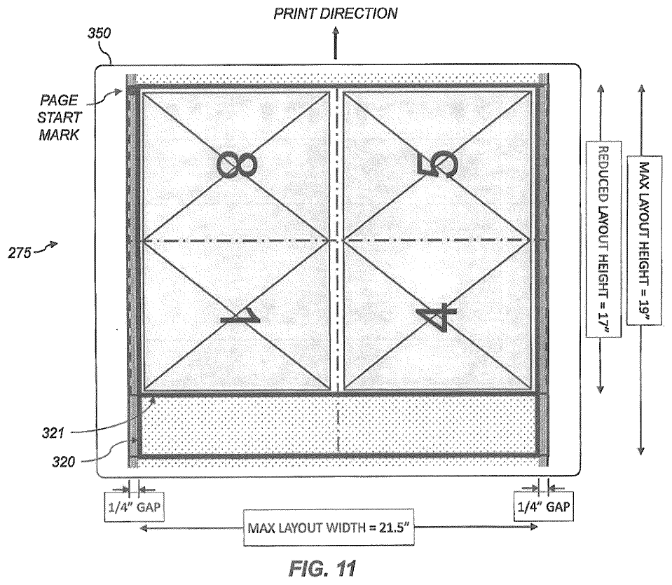

FIG. 11 illustrates an updated superimposition of the printing data in the adjusted layout position 275. In this case, the printing data has been positioned along the leading edge of the useable layout area 320, and the geometry of the layout area has been adjusted to form an adjusted layout area 321 by reducing the layout height to 17.0″ (2×8.25″+0.25″ buffer for trimming on the top and bottom) to minimize substrate usage. This reduces the amount of substrate needed to print the printing data from 19″ to 17″, thereby reducing the substrate waste by 2″. The positions of the cut lines and the fold lines have been adjusted accordingly to correspond to the page positions in the adjusted layout position 275.

In some embodiments, the printing data can be analyzed in the adjusted layout position 275 to confirm that none of the restrictions 230 have been violated. If so, a warning can be displayed on the softcopy display 240. In some cases, the restrictions 230 can include a maximum allowable colorant coverage for the substrate. In this case, the colorant coverage as a function of position can be determined, accounting for the image content printed on the front and back sides of the substrate to confirm that the restriction is not violated. If so, the user can be warned that artifacts may result unless the colorant usage is reduced (for example by modifying UCR/GCR parameters in the color management process).

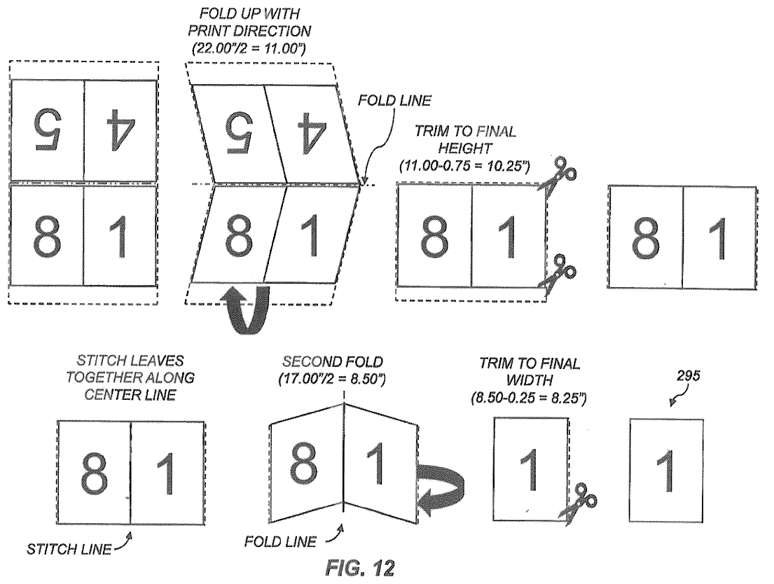

Once the final adjusted layout position 275 has been determined, a produce printed product step 290 (FIG. 2) is used to operate the printing system 200 to print the print job 255 with the printing data in the adjusted layout position 275 to produce a printed product 295. For the example print job of FIG. 9, the folding and cutting operations performed by the finishing system 205D (FIG. 3) are illustrated in FIG. 12. The printed substrate produced by the printing press 205C has a size of 22″×17″ and includes an imposition of four pages (#1, #4, #5, #8) printed on the front side, with an imposition of the other four pages being printed on the back side (page #2 being printed on the back side of page #1, page #3 being printed on the back side of page #4, page #6 being printed on the back side of page #5 and page #7 being printed on the back side of page #8).

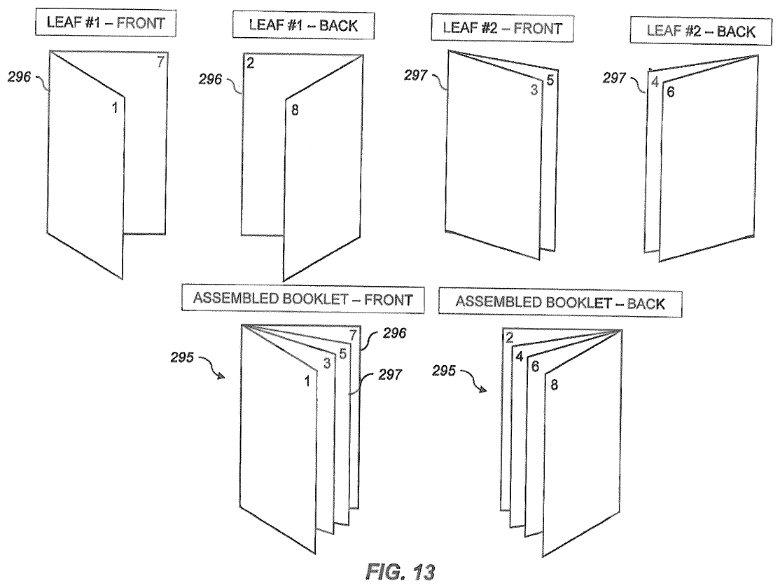

The finishing system 205D first performs a fold operation to fold the substrate in half in the long direction (along a line parallel to the print direction). The resulting folded substrate will have a height of 11.00″. A trimming operation is used to trim the height by a total of 0.75″ (0.25″ off the top edge and 0.50″ off the bottom edge) to provide a final height of 10.25″. Next, the two leaves are stitched together along the center line. A second trimming operation is then used to trim 0.25″ off the width giving a final width of 8.25″. The final printed product 295 is an 8-page booklet having a size of 10.25″×8.25″. The booklet consists of two interleaved leaves as illustrated in FIG. 13. The first leaf 296 will include pages #1, #2, #7 and #8, and the second leaf 297 will include pages #3, #4, #5 and #6.

In some embodiments, the layout system 300 (FIG. 3) can model the folding, trimming and stitching operations of the finishing system 205D to provide a preview of the printed product 295 to confirm that all of the pages are positioned properly in the final printed product 295. For example, a preview of the assembled booklet can be shown in a 3-D view as shown in FIG. 13. Alternately, the preview can enable the user to flip through a virtual preview of the booklet one page at a time.

In accordance with an exemplary embodiment, if the printing system 200 (FIG. 3) is modified (e.g., by adding or subtracting or changing printing system components 205), or if a different printing system 200 is selected, an updated printing system model 220 can be formed corresponding to the new set of printing system components 205. The user can then be enabled to determine a new adjusted layout position 275 (FIG. 2) which is optimized in accordance with the updated printing system model 220.

Aspects of the present invention are generally performed using a data processing system. The data processing system includes one or more data processing devices that implement the processes of the various embodiments of the present invention, including the example processes described herein. The phrases “data processing device” or “data processor” are intended to include any data processing device, such as a central processing unit (“CPU”), a desktop computer, a laptop computer, a mainframe computer, a tablet computer, a cellular phone, or any other device for processing data, managing data, or handling data, whether implemented with electrical, magnetic, optical, biological components, or otherwise.

A data storage system is generally communicatively connected with the data processing system and includes one or more processor-accessible memories configured to store information, including the information needed to execute the processes of the various embodiments of the present invention, such as the example processes described herein. The data storage system may be a distributed processor-accessible memory system including multiple processor-accessible memories communicatively connected to the data processing system via a plurality of computers or devices. On the other hand, the data storage system may include one or more processor-accessible memories located within a single data processor or device. The phrase “processor-accessible memory” is intended to include any processor-accessible data storage device, whether volatile or nonvolatile, electronic, magnetic, optical, or otherwise, including but not limited to, registers, hard disks, solid state disks, optical discs, flash memories, ROMs, and RAMs.

The phrase “communicatively connected” is intended to include any type of connection, whether wired or wireless, between devices, data processors, or programs in which data may be communicated. The phrase “communicatively connected” is intended to include a connection between devices or programs within a single data processor, a connection between devices or programs located in different data processors, and a connection between devices not located in data processors at all. In this regard, although the data storage system may be described separately from the data processing system, one skilled in the art will appreciate that the data storage system may be stored completely or partially within the data processing system.

A computer program product for implementing the present invention can include one or more non-transitory, tangible, computer readable storage medium, for example; magnetic storage media such as magnetic disk; optical storage media; solid-state electronic storage devices such as random access memory (RAM), or read-only memory (ROM); or any other physical device or media employed to store a computer program having instructions for controlling one or more data-processing systems to practice the method according to the present invention.

The invention has been described in detail with particular reference to certain preferred embodiments thereof, but it will be understood that variations and modifications can be effected within the spirit and scope of the invention.

### PARTS LIST

200 printing system
205 printing system components
205A unwinder
205B pre-coater
205C printing press
205D finishing system
210 form printing system model step
220 printing system model
225 component models
225A substrate supply model
225B pre-coater model
225C printing press model
225D finishing system model
230 restrictions
231 specifications
232 constraints
235 display restrictions step
240 softcopy display
250 receive print job step
255 print job
260 superimpose printing data step
265 initial layout position
270 determine initial layout position step
275 adjusted layout position
280 adjust layout position step
285 user interface components
290 produce printed product step
295 printed product
296 first leaf
297 second leaf
300 layout system
305 user
310 user interface
315 maximum layout area
320 usable layout area
321 adjusted layout area
325 front side
330 back side
335 fold lines
340 cut lines
350 graphical representation

1. A method for laying out printing data for a printing system including a plurality of printing system components, the plurality of printing system components including at least one printing module for printing on a substrate, comprising:
forming a component model for each of the plurality of printing system components, wherein the component models specify restrictions associated with the corresponding printing system components;
receiving a print job including printing data for one or more pages;
determining a useable layout area for the printing system based on the restrictions associated with the corresponding printing system components;
displaying a graphical representation of the restrictions associated with the plurality of printing system components together with the useable layout area on a softcopy display;
specifying an initial layout position of the printing data relative to the useable layout area;
adjusting the layout position of the printing data or a geometry of layout area to specify an adjusted layout position; and
superimposing a representation of the printing data in the adjusted layout position together with the graphical representation of the restrictions on the softcopy display.

2. The method of claim 1, wherein the adjusted layout position is determined automatically in accordance with one or more predefined criteria.

3. The method of claim 1, wherein the adjusted layout position is specified by a user utilizing user interface components.

4. The method of claim 1, wherein the plurality of printing system components include a substrate supply, a substrate unwinder, a substrate rewinder, a pre-coater, a post-coater, a cutting system, a folding system, a binding system, or a finishing system.

5. The method of claim 1, wherein the printing module is an inkjet printing module, an electrophotographic printing module, an offset printing press, or a flexographic printing press.

6. The method of claim 1, wherein the restrictions include physical dimensions of the substrate, maximum allowable colorant coverage of the substrate, limitations on the substrate dimensions on which the printing system components can operate, maximum printable area of the printing modules, or space required for registration marks.

7. The method of claim 1, wherein at least some of the restrictions are specified by automatically querying the plurality of printing system components.

8. The method of claim 1, wherein at least some of the restrictions are specified by manual user entry using a user interface.

9. The method of claim 1, wherein the initial layout position is determined by automatically analyzing the printing data to determine an acceptable layout position.

10. The method of claim 9, wherein the printing data includes a plurality of pages, and wherein determining the acceptable layout position includes positioning the plurality of pages relative to cut lines associated with a cutting system or fold lines associated with a folding system.

11. The method of claim 1, further including automatically analyzing the printing data in the adjusted layout position to determine whether any of the restrictions are violated and if so displaying a warning on the softcopy display.

12. The method of claim 1, wherein the printing data includes a plurality of pages, and further including displaying a preview of a printed product to be produced by printing the printing data using the printing system to enable a user to confirm that the plurality of pages are positioned properly in the printed product.

13. The method of claim 1, further including operating the printing system to print the printing data in the adjusted layout position to produce a printed product.

14. A method for laying out printing data for a printing system including a plurality of printing system components, the plurality of printing system components including at least one printing module for printing on a substrate, comprising:
forming a component model for each of the plurality of printing system components, wherein the component models specify restrictions associated with the corresponding printing system components;
determining a useable layout area for the printing system based on the restrictions associated with the corresponding printing system components;
receiving a print job including printing data for one or more pages;
automatically analyzing the printing data to determine an initial layout position of the printing data relative to the useable layout area; and
superimposing a representation of the printing data in the initial layout position together with a graphical representation of the restrictions associated with the plurality of printing system components and the useable layout area on a softcopy display.

15. The method of claim 14, further including providing user interface components to enable a user to adjust the layout position.

16. A computer program product for laying out printing data for a printing system including a plurality of printing system components, the plurality of printing system components including at least one printing module for printing on a substrate, the computer program product comprising a computer readable storage medium storing an executable software application for causing a data processing system to perform the steps of:
forming a component model for each of the plurality of printing system components, wherein the component models specify restrictions associated with the corresponding printing system components;
receiving a print job including printing data for one or more pages;
determining a useable layout area for the printing system based on the restrictions associated with the corresponding printing system components;
displaying a graphical representation of the restrictions associated with the corresponding printing system components together with the useable layout area on a softcopy display;
specifying an initial layout position of the printing data relative to the useable layout area;
adjusting the initial layout position of the printing data or a geometry of layout area to specify an adjusted layout position; and
superimposing a representation of the printing data in the adjusted layout position together with the graphical representation of the restrictions on the softcopy display.
